(19) United States
(12) Patent Application Publication
(10) Pub. No.: US 2008/0010195 A1
(43) Pub. Date: Jan. 10, 2008

(54) POWER FAILURE COMPENSATION METHOD OF LAUNDRY ROOM MACHINE AND MACHINE THEREFOR

(75) Inventors: Hea-Kyung Yoo, Changwon-shi (KR); Tae-Hoon Lim, Changwon-shi (KR)

Correspondence Address: KED & ASSOCIATES, LLP, P.O. Box 221200, Chantilly, VA, 20153-1200, US

(73) Assignee: LG Electronics Inc.

(21) Appl. No.: 11/753,027

(22) Filed: May 24, 2007

(30) Foreign Application Priority Data
May 26, 2006 (KR) 10-2006-0047735

(51) Int. Cl. D06F 33/00; D06F 35/00; G06Q 40/00

(52) U.S. Cl. 705/39

(57) ABSTRACT

The present invention discloses a power failure compensation method for a laundry room machine that includes a payment device for collecting a payment for operating a laundry room machine, and an interface for communicating with a communicator. The method includes: a) detecting power failure by determining whether or not a pulse generated from an AC (alternative current) power is interrupted for a predetermined time; b) storing compensation data having information about a state of a laundry room machine when power failure occurs; and c) operating the laundry room machine according to the stored compensation data when the power is supplied again.

### TECHNICAL FIELD

The present invention relates to a power failure compensation method of a laundry room machine and a machine therefor, and more particularly, to a power failure compensation method for storing a state of a laundry room machine when power failure occurs and operating the laundry room machine according to the stored state when electric power is supplied again, and a machine therefor.

### BACKGROUND ART

FIG. 1 is a flowchart illustrating a method of operating a laundry room machine according to the related art.

Referring to FIG. 1, the method according to the related art includes a payment insertion step S1 for inserting a card or a coin, a course selection step S2 for selecting a washing course or a drying course according to characteristics of the laundry by a user, and an operating step S3 for operating the laundry room machine to perform at least one of a washing operation and a drying operation for a time set according to the course selected at the step S2.

According to the conventional method of operating a laundry room machine, following problems may be arisen when power failure occurs. A laundry room machine cannot remember previously performed operations and the operating state thereof before the electric power is interrupted. Also, a user may lose a payment inserted into the laundry room before the power failure occurs because the operating state of the laundry room machine changes to an initial state when the electric power is back on. Furthermore, since the laundry room machine performs the same operations repeatedly from the initial state again after the electric power is back on, the electric power may be wasted and the laundry may be damaged.

Due to such problems, it is difficult to use the laundry room machine in areas with unstable power source.

When electric power is interrupted for a very short time, a user may not recognize the power failure. In this case, the laundry may be left along although the laundry room machine stops in middle of operation.

### DISCLOSURE OF THE INVENTION

The present invention is achieved to solve the above problems. An object of the present invention is to provide a power failure compensation method for preventing a user from losing a payment inserted before power failure occurs by storing compensation data including information about performed operations and an operating state of a laundry room machine when the power failure occurs and save energy by reducing repeated operations of the laundry room machine.

Another object of the present invention is to provide a power failure compensation method for facilitating the use of laundry room machines in areas with unstable power source.

Yet another object of the present invention is to provide a power failure compensation method for detecting short power failure and performing incomplete operation again according to compensation data stored when the short power failure occurs.

In order to achieve the above-described objects of the invention, there is provided a power failure compensation method for compensating a power failure of a laundry room machine that includes a payment device for collecting a payment for operating a laundry room machine, and an interface for communicating with a communicator, is used for performing at least one of a washing operation and a drying operation, receives payment insertion information from the payment device, receives a selection of courses allowable by the inserted payment, and performs a predetermined operation according to the selected course, including the steps of: a) detecting power failure by determining whether or not a pulse generated from an AC (alternative current) power is interrupted for a predetermined time; b) storing compensation data having information about a state of a laundry room machine when power failure occurs; and c) operating the laundry room machine according to the stored compensation data when the power is supplied again.

The compensation data may include at least one of an inserted payment, a selected course, a remaining time of the selected course.

The predetermined time of the step a) may be about 20 msec.

In another aspect of the present invention, there is provided a commercial laundry room machine including: an interface for communicating payment collecting information with a payment device disposed corresponding to each laundry room machine; a control panel for controlling operation of a laundry room machine according to communicating information of the interface, storing compensation data including information about a state of a laundry room machine when electric power is interrupted, and operating the laundry room machine according to the compensated data.

The compensation data may include at least one of inserted payment, a selected course, and a remaining time of a selected course. The laundry room machine may further include a display unit for displaying operating state and/or compensation data, and The laundry room machine may be a washer or a dryer.

### BRIEF DESCRIPTION OF THE DRAWINGS

The present invention will become better understood with reference to the accompanying drawings which are given only by way of illustration and thus are not limitative of the present invention, wherein:

FIG. 1 is a diagram illustrating a power failure compensation method according to the related art;

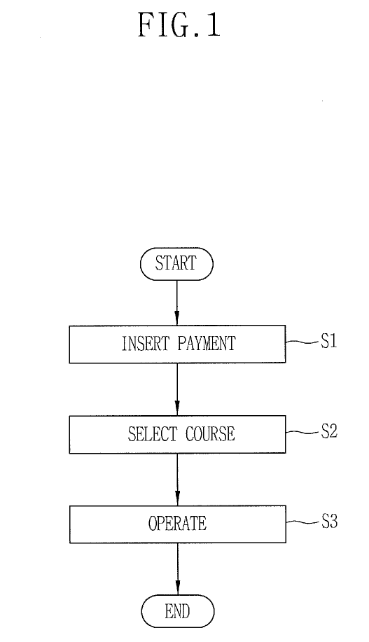

FIG. 2 is a diagram illustrating a laundry room machine according to an embodiment of the present invention;

FIG. 3 is a diagram illustrating a control panel of a laundry room machine for a power failure method according to an embodiment of the present invention; and

FIG. 4 is a flowchart illustrating a power failure compensation method failure according to an embodiment of the present invention.

### BEST MODE FOR CARRYING OUT THE INVENTION

A power failure method in accordance with preferred embodiments of the present invention will now be described in detail with reference to the accompanying drawings.

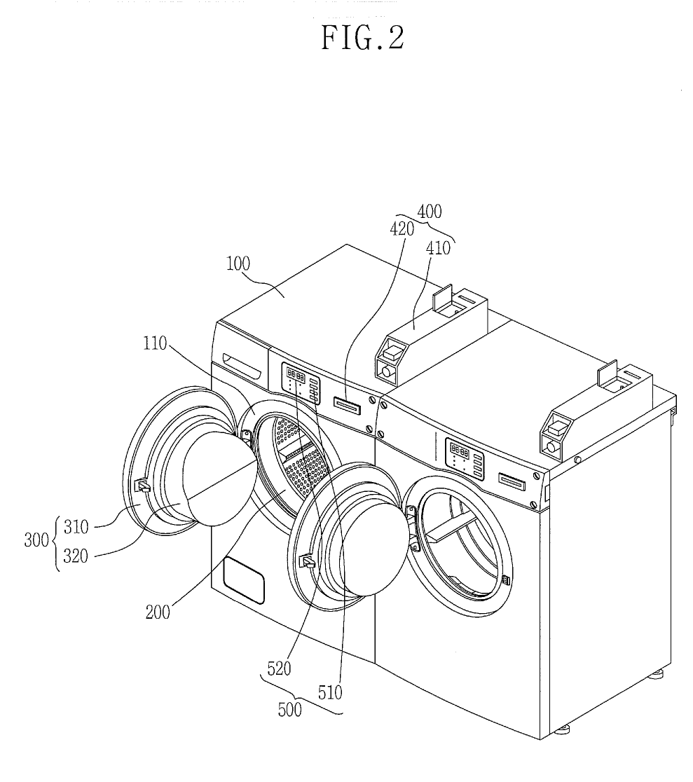

FIG. 2 is a diagram illustrating a laundry room machine according to an embodiment of the present invention.

Referring to FIG. 2, the laundry room machine according to the present embodiment includes a body 100, a drum 200, a door 300, a payment device 400, and a control panel 500.

The body 100 is formed in a hollow shape so the drum 200 can be disposed in the body 100. An opening 100 is formed at one side of the body 100. In the present embodiment, the body 100 is formed in a hexahedron box shape, and the opening 110 is formed in a circle shape.

The drum 200 houses the laundry and is rotatably disposed in the body 100. In the present embodiment, the drum 200 has a cylindrical shape having one side opened and the other closed. In order to enable a user to put the laundry in the drum 200 or to take the laundry out from the drum 200 through the opening 100 of the body 100, the opened end of the drum 200 is arranged to face the opening 110 of the body 100.

The door 300 is connected to the opening 110 to open and close the drum 200. In the present embodiment, the door 300 includes a frame 310 and an opening and closing member 320. The frame 310 is formed in a ring disk shape and has one side connected to the opening 110 through a hinge. The opening and closing member 320 is disposed in the frame 310. Since the opening and closing member 320 is formed in a basket shape, the opening and closing member 320 opens and closes the opening 110 of the body 100 and the opened one side of the drum 200 at the same time. It is preferable that the opening and closing member 320 is made of a transparent material to enable a user to see through the inside of the drum 200.

The payment device 400 is disposed at the body 100 to collect a payment for operating the laundry room machine. In the present embodiment, the payment device 400 receives coins or a card as the payment. That is, a coin drop assembly 410 is disposed on a top of the body 100 to collect coins, and a card reader 420 is disposed at an upper front side of the body 100 to receive the card.

The control panel 500 receives payment insertion information from the payment device 400 and controls the laundry room machine to perform at least one of a washing operation and a drying operation according to a selected course. In the present embodiment, the control panel 500 is disposed at an upper front side of the body 100 and includes an input unit 510 and a display unit 520. The input unit 510 includes buttons for setting a washing course or a drying course. The display unit 520 displays information about a time or a course set according to a user's unit.

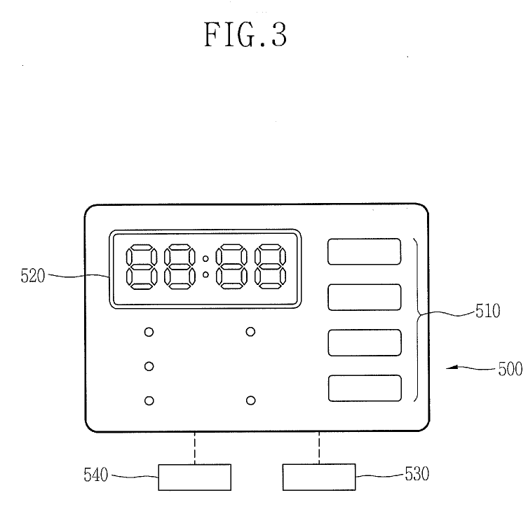

FIG. 3 is a diagram illustrating a control panel of a laundry room machine for a power failure method according to an embodiment of the present invention.

Referring to FIG. 3, the display unit 520 of the control panel 500 displays at least one of numbers, characters, symbols, and figures to show information about washing courses, drying courses, and remaining times. Also, the control panel 500 includes a storage medium 530 for storing various data. In the present embodiment, an electrically erasable programmable read only memory (EEPROM) may be included as the storage medium 500. The EEPROM can record and erase information electrically by radiating storing ultraviolet rays. Also, the control panel 500 includes an active element 540 for storing energy required for power failure compensation after power failure occurs. In the present embodiment, as the active element 540, the control panel 500 may include a capacitor having capacity that can operate the control panel 500 at least for 75 msec.

Accordingly, when a user inserts a payment to the payment device 400 for operating the laundry room machine, the control panel 500 receives the payment insertion information from the payment device 400 and receives a user selection of a course among courses allowed by the inserted payment through the input unit 510. The control panel 500 controls the laundry room machine to perform at least one of a washing operation and a drying operation according to the selected course. In the present embodiment, the alternative current (AC) power having a frequency of about 50 Hz is used as the power source of the laundry room machine.

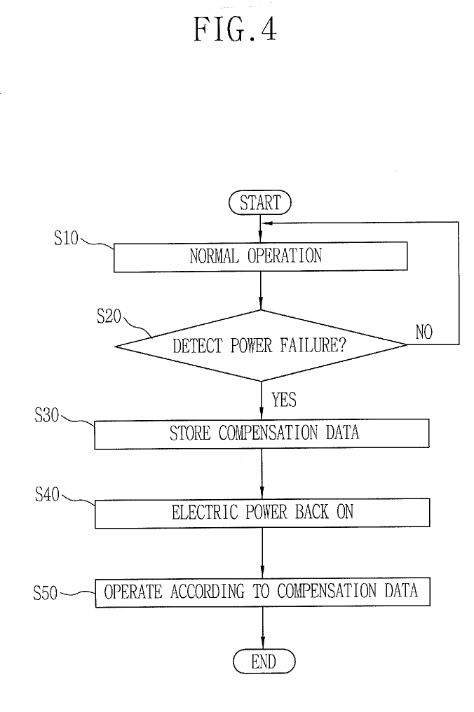

FIG. 4 is a flowchart illustrating a power failure compensation method failure according to an embodiment of the present invention.

Referring to FIG. 4, the method according to the present embodiment includes a first step S10, a second step S30, and a third step S40.

At the first step S20, it is determined whether the pulse of AC power is interrupted for a predetermined time period while the laundry room machine performs at least one of a washing operation and a drying operation at step S10. In the present embodiment, the predetermined time period is set to about 20 msec and the AC power has a frequency of about 50 Hz. At the step S20, if a pulse generated from 50 Hz of the AC power has been interrupted for about 20 msec, the control panel 50 determines that power failure occurs. Accordingly, the control panel 500 can detect the power failure and perform a power compensating operation therefor although the electric power has been interrupted for very short time. If the power failure is not detected at the step S20, the controller 500 normally performs at least one of a washing operation and a drying operation at step S10.

At the second step S30, compensation data is stored. The compensation data includes information about a state of a laundry room machine when the power failure. In the present embodiment, the compensation data includes at least one of information about an inserted payment, a selected course, and a remaining time of the selected course. If the power failure is detected at the step S20, the control panel 500 stores the compensation data into the storage medium 530 using small amount of energy stored in the active element 540 at step S30. In order to store the compensation data using the energy stored in the active element 540, the size of the compensation data is 9 bytes and the compensation data is stored at a speed of 5 msec per byte in the present embodiment. The size of the compensation data and the speed of storing the compensation data may vary according to the capacity of the active element 540.

At the third step S50, the laundry room machine is operated according to the stored compensation data when the AC power is back on at step S40. In the present embodiment, when the electric power is supplied again at step S40, the control panel 530 determines whether compensation data is stored in the storage medium 530 or not. If the storage medium 530 stores the compensation data, the control panel 500 performs at least one of a washing operation and a drying operation according to the compensation data.

According to the power failure compensation method of the present invention, a user can be prevented from losing a payment inserted before power failure occurs by storing compensation data including information about performed operations and an operating state of a laundry room machine when the power failure occurs. Also, energy can be saved by reducing repeated operations of the laundry room machine.

Furthermore, the use of laundry room machines can be facilitated even in areas with unstable power source.

Although the electric power has been interrupted for very short time, it can be detected and compensation data thereof can be stored. Therefore, the laundry room machine can finish incomplete operation according to the compensation data stored when the short power failure.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A power failure compensation method for compensating a power failure of a laundry room machine that includes a payment device for collecting a payment for operating a laundry room machine, and an interface for communicating with a communicator, is used for performing at least one of a washing operation and a drying operation, receives payment insertion information from the payment device, receives a selection of courses allowable by the inserted payment, and performs a predetermined operation according to the selected course, comprising the steps of:
a) detecting power failure by determining whether or not a pulse generated from an AC (alternative current) power is interrupted for a predetermined time;
b) storing compensation data having information about a state of a laundry room machine when power failure occurs; and
c) operating the laundry room machine according to the stored compensation data when the power is supplied again.

2. The power failure compensation method of claim 1, wherein the compensation data includes at least one of an inserted payment, a selected course, a remaining time of the selected course.

3. The power failure compensation method of claim 1, wherein the predetermined time of the step a) is about 20 msec.

4. A commercial laundry room machine comprising:
an interface for communicating payment collecting information with a payment device disposed corresponding to each laundry room machine;
a control panel for controlling operation of a laundry room machine according to communicating information of the interface, storing compensation data including information about a state of a laundry room machine when electric power is interrupted, and operating the laundry room machine according to the compensated data.

5. The commercial laundry room machine of claim 4, wherein the compensation data includes at least one of inserted payment, a selected course, and a remaining time of a selected course.

6. The commercial laundry room machine of claim 5, wherein the laundry room machine further includes a display unit for displaying operating state and/or compensation data.

7. The commercial laundry room machine of claim 4, wherein the laundry room machine is a washer or a dryer.
